(19) United States
(12) Patent Application Publication
(10) Pub. No.: US 2009/0241422 A1
(43) Pub. Date: Oct. 1, 2009

(54) Impact-Resistant Window

(76) Inventors: Loren D. Mock, Baldwin City, KS (US); Steve Gramling, Olathe, KS (US)

Correspondence Address: WOMBLE CARLYLE SANDRIDGE & RICE, PLLC, ATTN: PATENT DOCKETING, P.O. BOX 7037, ATLANTA, GA, 30357-0037, US

(21) Appl. No.: 12/058,190

(22) Filed: Mar. 28, 2008

(51) Int. Cl. E05D 15/38; E06B 3/30

(52) U.S. Cl. 49/197; 52/204.53

(57) ABSTRACT

A universal impact-resistant window assembly for a garage door of a type having a sheet-metal face skin includes a window assembly adaptable for installation in both insulated and non-insulated garage doors. The assembly includes an impact-resistant window pane, and an interior metal frame installed within and around a window opening in the sheet-metal face skin. An exterior metal frame is installed within and around the window opening in the sheet-metal face skin. The exterior metal frame cooperates with the interior metal frame to engage portions of the sheet-metal face skin that surround the window opening, and to retain the window pane. An exterior trim member substantially covers exterior portions of the exterior metal frame, and an optional interior trim member substantially covers interior portions of the interior metal frame. A rear flange of the optional interior trim member at least partially supports an insulating panel proximate to the sheet-metal face skin when the window assembly is installed in an insulated door.

### FIELD OF THE INVENTION

The invention relates to windows and window frames, and more particularly relates to an impact-resistant window assembly for sheet metal garage doors that can be configured and adapted for use with both insulated and non-insulated doors.

### BACKGROUND

Modern residential garage doors can include a plurality of windows or “lights” that admit light and permit viewing through the doors. Overhead sectional garage doors can include such windows in an uppermost door panel that positions the windows at about eye level when the garage door is closed, for example. Such windows also can be arranged in another door section or in multiple door sections if desired. Such doors can typically include glass panes that are retained and supported within a window opening in a sheet metal door panel by a plastic frame or molding.

Though such garage door windows can be both attractive and useful, such windows can be subjected to high wind pressure loads and flying objects during severe weather conditions, such as tornados and hurricanes. In some locales where such severe weather conditions are most likely, governments have enacted building codes that require such windows to be resistant to impacts by airborne missiles, such as wind-propelled debris, and to cyclic wind pressure loadings. For example, in Florida, testing application standard TAS 201-94 sets forth test procedures for demonstrating adequate resistance to large missile impact as required by Section 1626 of the Florida Building Code, Building, and TAS 203-94 sets forth test procedures for demonstrating adequate resistance to cyclic wind pressure loading as required by the Florida Building Code and TAS 201-94.

Unfortunately, the plastic frames and glass panes of typical glazed garage doors fail under such severe impact and pressure conditions. Accordingly, there is a need for an impact-resistant window assembly for garage doors that meets the demanding criteria set forth in the most stringent modern building codes and standards. As used herein, the term “impact-resistant” means resistant to failure when subjected to impacts from airborne missiles which, under identical conditions, would cause a conventional plain glass window pane supported in a door by an all-plastic window frame to fail.

Metal garage doors generally are produced in two general types: insulated doors and non-insulated doors. As used herein, the term “insulated” means including added thermal insulation having a resistance to heat transfer that is substantially greater than the resistance to heat transfer characteristic of steel or aluminum. Insulated metal garage doors typically include a plurality of sheet metal door panels backed by a panel of thermally insulating material. For example, each thin metal door section may be backed by polymeric foam panel having a thickness of about one-two inches. Because the sheet metal door panels are highly thermally conductive, the sheet metal skins of such doors do little to resist heat transfer through the door. The insulating panels act to block the transfer of heat through the door that otherwise would occur. Thus, such insulated garage doors are especially useful for installation in entryways to garages or other spaces that are actively heated or cooled. In contrast, non-insulated garage doors essentially include only the sheet metal door panels, and are best-suited for installation in entryways to garages or other spaces that are not actively heated or cooled. Apart from their insulating panels, insulated metal garage doors can be substantially identical to non-insulated metal garage doors.

When an insulated metal garage door includes at least one glazed panel, the associated insulating panel that backs the sheet metal face skin necessarily includes one or more window openings that align with corresponding openings in the sheet metal face skin. Because the insulating panels typically are constructed of polymeric foam materials that are soft and brittle and can be easily damaged or broken, the portions of an insulating panel that surround a window opening are vulnerable to damage if left unprotected, and require support on the back of the door panel. Accordingly there is a need to support and shield the exposed edges of an insulating panel that surround a window opening in an insulated metal garage door panel. Of course, because non-insulated metal door panels don't include insulating panels, there is no need to support and shield the edges of an insulating panel that surround a window opening in such a door panel.

Accordingly, there is a need for a universal impact-resistant window assembly for a metal garage door that can be adapted for use in door sections both with and without an insulation panel backing the section's sheet metal face skin. When used in an insulated door section, such a universal window assembly should be configured to support and shield the edges of an insulating panel that border an associated window opening in the door section.

### SUMMARY

In one embodiment, the invention includes a universal impact-resistant window assembly for a garage door of a type having a sheet-metal face skin. The window assembly is adaptable for installation in both insulated and non-insulated garage doors. The window assembly includes an impact-resistant window pane, and an interior metal frame configured to be installed within and around a window opening in the sheet-metal face skin. An exterior metal frame is configured to be installed within and around the window opening in the sheet-metal face skin, and is configured to cooperate with the interior metal frame to engage portions of the sheet-metal face skin that surround the window opening, and to retain the window pane therebetween. An exterior trim member is configured to substantially cover exterior portions of the exterior metal frame, and an optional interior trim member is configured to substantially cover interior portions of the interior metal frame. The interior trim member includes a rear flange configured to at least partially support an insulating panel proximate to the sheet-metal face skin when the window assembly is installed in an insulated door.

In another embodiment, an impact-resistant window assembly is adapted for installation in a window opening in an insulated garage door or a non-insulated garage door, such door being of a type having a sheet metal face skin with a window opening therein. The window assembly includes a window pane, and an interior metal frame having a forward lip and a rear lip, the rear lip being inwardly offset from the forward lip. The window assembly also includes an exterior metal frame having an exterior lip, a rear land that is inwardly offset from the exterior lip, and a pane-retaining lip. The interior metal frame is disposed around the window opening on an interior side of the face skin, the forward lip of the exterior metal frame is disposed around the window opening on an exterior side of the face skin, and the interior metal frame is connected to the exterior metal frame. Portions of the sheet metal face skin are sandwiched between the forward lip and the exterior lip, and the window pane is retained within the window opening between the rear lip and the pane-retaining lip.

Another embodiment of the invention includes a garage door having at least one impact-resistant window assembly for selective installation in either an insulated sheet metal door panel or a non-insulated sheet metal door panel. The window assembly includes an impact-resistant window pane, and a frame arranged and constructed to securely support the window pane within a window opening in the sheet metal door panel. An interior member is configured to be optionally removably connected to an interior portion of the frame, and includes a rearwardly extending flange arranged and constructed to at least partially support one or more insulation panels proximate to an interior side of sheet metal door panel of an insulated sheet metal door panel. The interior member can be excluded from the window assembly when the window assembly is installed in a non-insulated sheet metal door panel without one or more insulation panels.

These and other aspects of the invention will be apparent from a reading of the following detailed description, together with the drawings.

### BRIEF DESCRIPTION OF THE DRAWINGS

FIG. 1 is an exterior elevation view of a metal sectional overhead door including a plurality of universal impact resistant window assemblies according to the invention.

FIG. 2 is an interior elevation view of a non-insulated glazed door panel of the garage door shown in FIG. 1.

FIG. 3 is an interior elevation view of an insulated glazed door panel of the garage door shown in FIG. 1.

FIG. 4 is a cross-sectional view of the non-insulated glazed door panel shown in FIG. 2 taken along section line 4-4.

FIG. 5 is a cross-sectional view of the insulated glazed door panel shown in FIG. 3 taken along section line 5-5.

FIG. 6 is an interior elevation view of an impact-resistant window assembly installed in a non-insulated glazed door panel like that shown in FIG. 2.

FIG. 7 is a cross-sectional view of the impact-resistant window assembly shown in FIG. 6 taken along section line 7-7.

FIG. 8 is a cross-sectional view of the impact-resistant window assembly shown in FIG. 6 taken along section line 8-8.

FIG. 9 is an interior elevation view of an impact-resistant window assembly installed in an insulated glazed door panel like that shown in FIG. 3.

FIG. 10 is a cross-sectional view of the impact-resistant window assembly shown in FIG. 9 taken along section line 10-10.

FIG. 11 is a cross-sectional view of the impact-resistant window assembly shown in FIG. 9 taken along section line 11-11.

FIG. 12 is a perspective view of an interior metal frame portion of the window assemblies shown in FIGS. 6-11.

FIG. 13 is a cross-sectional view of the interior metal frame shown in FIG. 12 taken along section line 13-13.

FIG. 14 is a cross-sectional view of the interior metal frame shown in FIG. 12 taken along section line 14-14.

FIG. 15 is a perspective view of an exterior metal frame portion of the window assemblies shown in FIGS. 6-11.

FIG. 16 is a cross-sectional view of the exterior metal frame shown in FIG. 15 taken along section line 16-16.

FIG. 17 is a cross-sectional view of the exterior metal frame shown in FIG. 15 taken along section line 17-17.

FIG. 18 is a perspective view of a corner portion of the exterior metal frame shown in FIGS. 15-17.

FIG. 19 is a perspective view of an exterior trim member portion of the window assemblies shown in FIGS. 6-11.

FIG. 20 is a cross-sectional view of the exterior trim member shown in FIG. 19 taken along section line 20-20.

FIG. 21 is a perspective view of an interior trim member portion of the window assembly shown in FIGS. 9-11.

FIG. 22 is a cross-sectional view of the interior trim member portion shown in FIG. 21 taken along section line 22-22.

### DETAILED DESCRIPTION

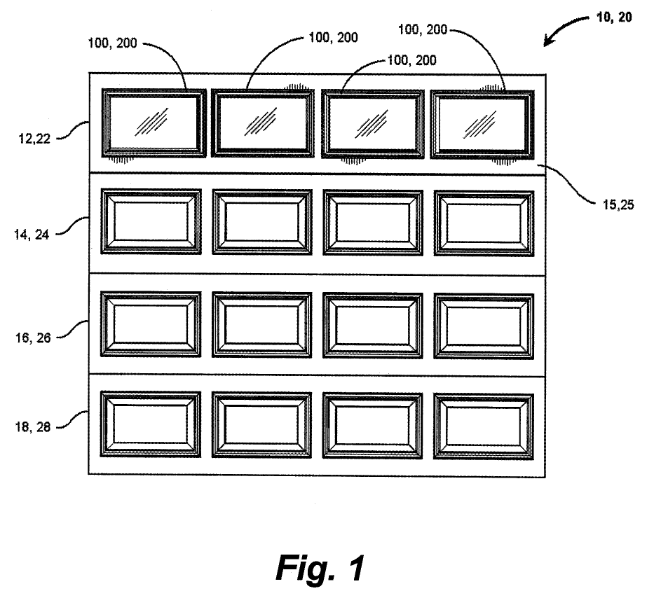

FIG. 1 shows a metal sectional overhead garage door 10, 20 according to the invention. In one embodiment, the door is a non-insulated door 10 that includes at least one glazed door section 12, and a plurality of non-glazed door sections, 14, 16 and 18. The glazed door section 12 includes a sheet metal face skin 15 having a plurality of window openings or apertures in which impact-resistant window assemblies 100 are installed. In another embodiment also shown in FIG. 1, the door can be an insulated door 20 that includes at least one glazed door section 22, and a plurality of non-glazed door sections, 24, 26 and 28. The glazed door section 22 includes a sheet metal face skin 25 having a plurality of window openings or apertures in which impact-resistant window assemblies 200 are installed. As discussed in detail below, the window assemblies 100, 200 can have a substantial number of common components, such that in a first configuration 100, the window assembly can be installed in a non-insulated door 10, and in a second configuration 200, the window assembly can be installed in an insulated door 20.

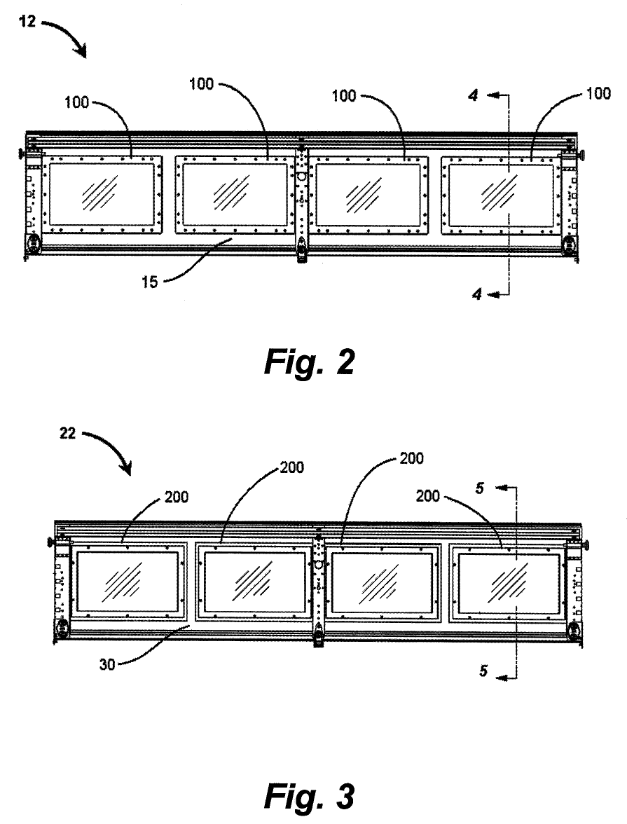

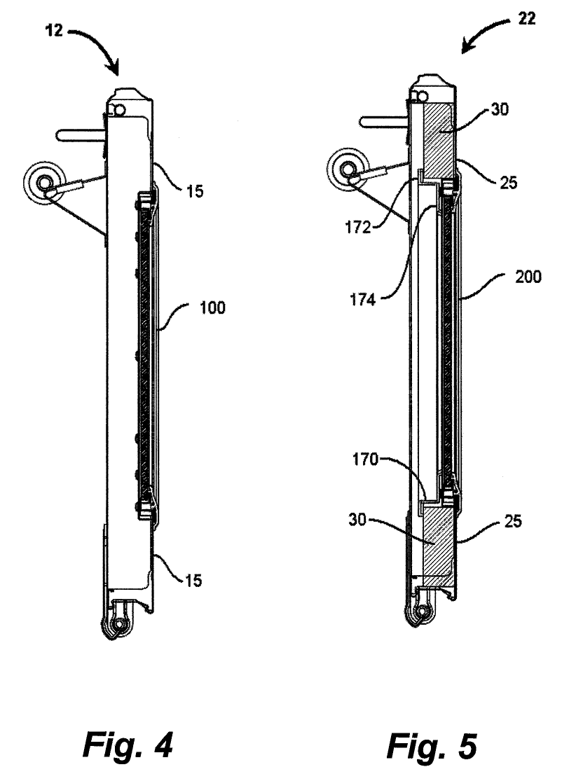

FIG. 2 shows a rear or interior view of a glazed non-insulated door panel 12. As shown in FIGS. 2 and 4, the interior surface of the sheet metal face skin 15 is exposed, and the window assemblies 100 are supported within spaced apertures in the face skin 15. FIG. 3 shows a rear or interior view of a glazed insulated door panel 22. As shown in FIGS. 3 and 5, the interior surface of the sheet metal face skin 25 is substantially covered by one or more insulation panels 30, including portions of the face skin 25 around each of the window assemblies 200. As shown in FIG. 5, a rear portion 170 of each window assembly 200 is configured to cover and protect inside edges of the insulation panel that surround the window assembly 200, and to at least partially support and retain the insulation panel 30 behind the sheet metal face skin 25.

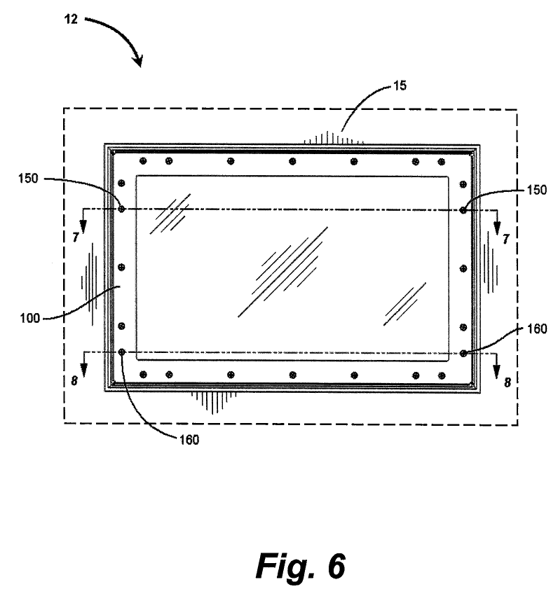

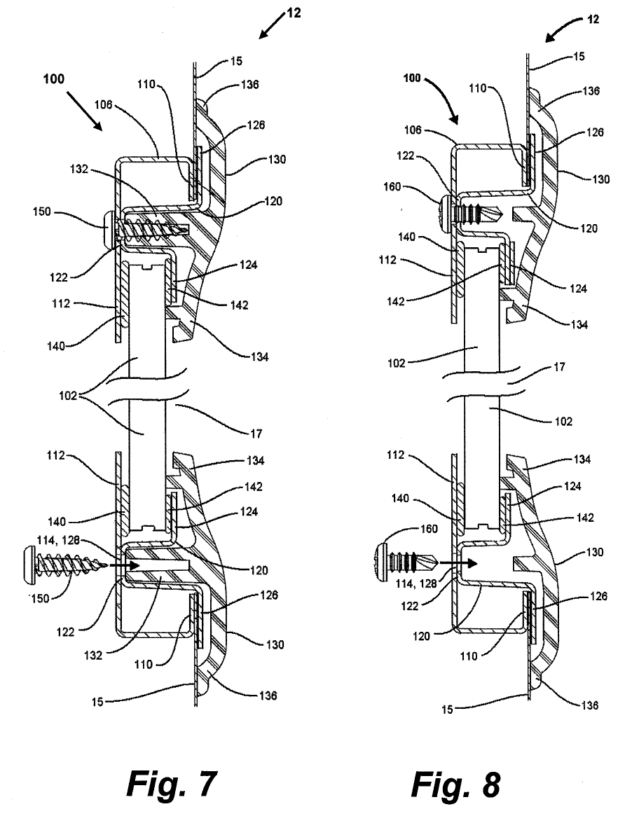

Details of one embodiment of an impact-resistant window assembly 100 for use in a non-insulated sheet metal door section 12 are shown in FIGS. 6-8, and are described below. As shown in FIG. 7, the window assembly 100 is configured to be assembled within an aperture 17 in a thin sheet metal face skin 15 of a door section 12. The window assembly 100 includes an impact-resistant window pane 102, an exterior metal frame 120, an interior metal frame 106, and an exterior trim member 130. The impact-resistant window pane 102 can be laminated glass, polycarbonate, or any other substantially transparent impact-resistant material or combination of materials.

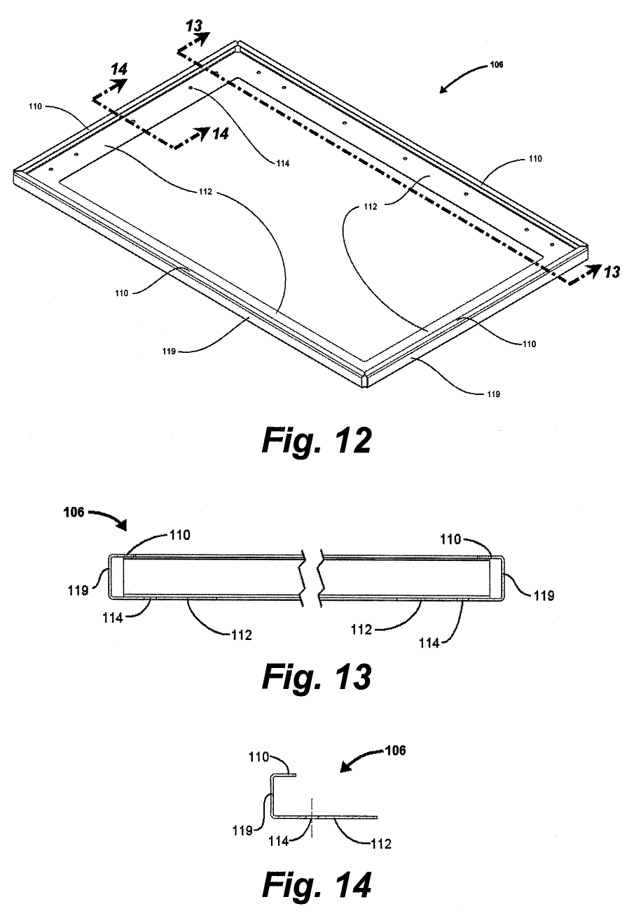

One embodiment of an interior metal frame 106 for use in an impact-resistant window assembly 100 according to the invention is shown in FIG. 7 and in FIGS. 12-14. In this embodiment, the interior metal frame 106 has a substantially rectangular shape, and includes a forward lip 110, a rear lip 112, and an outer wall 119 connecting the forward lip 110 to the rear lip 114. As shown in FIG. 12, the interior metal frame 106 can be constructed from a single piece of sheet material. A plurality of spaced screw holes 114 can be located in the rear lip 112. The interior metal frame 106 can be constructed of steel, such as galvanized low-carbon commercial steel, or any other suitable material. When constructed of steel, the frame 106 can have a nominal thickness of at least about 0.03 inch.

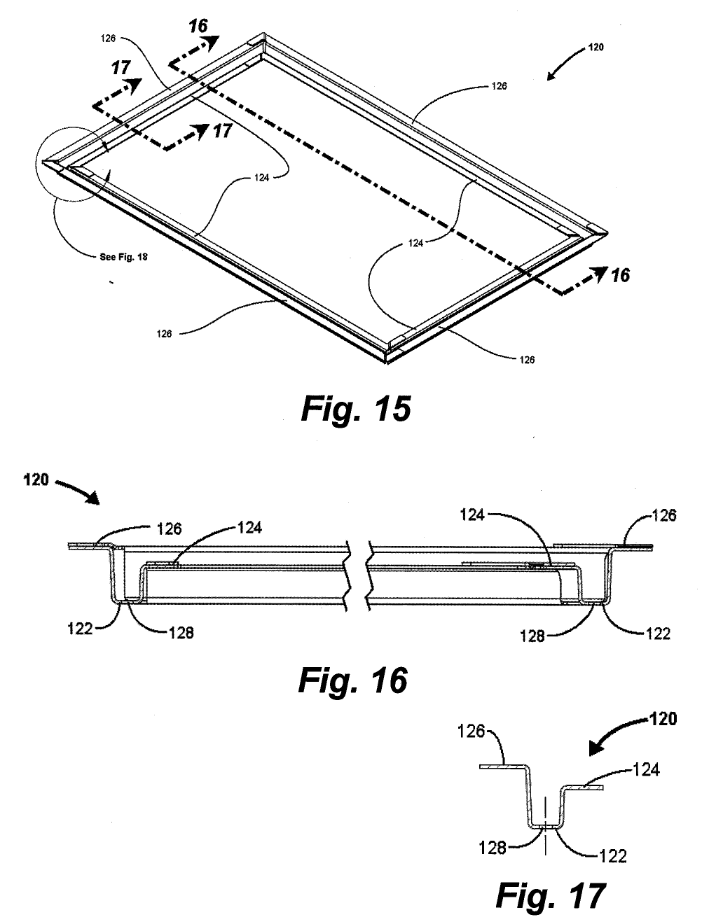

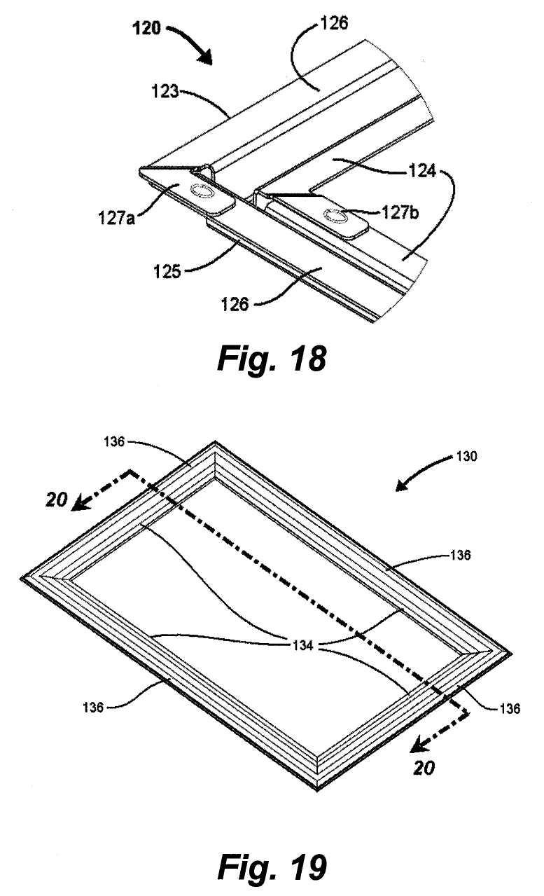

One embodiment of an exterior metal frame 120 for use in an impact-resistant window assembly 100 according to the invention is shown in FIG. 7 and in FIGS. 15-18. In this embodiment, the exterior metal frame 120 has a substantially rectangular shape, and includes an exterior lip 126, a rear land 122, and a pane-retaining lip 124. As shown in FIGS. 16 and 17, a plurality of screw holes 128 can be provided in the rear land 122. As shown in FIG. 18, the exterior metal frame 120 can be constructed of a pair of opposed vertical members 123 and a pair of opposed horizontal members 126. Each end of each vertical member 123 can be joined to an end of a horizontal member 126 by tabs 127a, 127b. As shown in FIG. 18, the tabs 127a, 127b can be arranged to overlap adjacent portions of an exterior lip 126 and a pane-retaining lip 124, respectively, and connected thereto by one or more spot welds, for example. Alternatively, the exterior metal frame 120 can be formed from a single piece of material. Like the interior metal frame 106, the exterior metal frame 120 can be constructed of steel, such as galvanized low-carbon commercial steel, or any other suitable material. When constructed of steel, the frame 120 can have a nominal thickness of at least about 0.03 inch.

As shown in FIG. 7, the interior frame 106 can be positioned around a window opening 17 in the sheet metal face skin 15 of a door panel 12 such that the forward lip 110 abuts the interior surface of the face skin 15. As also shown in FIG. 7, the exterior metal frame 120 can be positioned such that the rear land 122 and pane-retaining lip 124 are within the window opening 17, and the exterior lip 126 abuts the exterior surface of the of the face skin 15 around the opening 17. As shown in FIG. 8, a first plurality of screws 160 can be engaged through aligned screw holes 114 and 128 in the frames 106, 120, thereby securely connecting the frames together. As shown in FIGS. 7 and 8, the forward lip 110 of the interior frame 106 and the exterior lip 126 of the exterior frame 120 cooperate to sandwich edges of the face skin 15 around the opening between the two frames 120, 106, thereby securely supporting the connected frames 106, 120 in the opening 17.

As also shown in FIGS. 7 and 8, when the interior frame 106 and exterior frame 120 are assembled in the opening 17 as described above, the rear lip 112 of the interior frame 106 and the pane-retaining lip 124 of the exterior frame 120 cooperate to receive and support a window pane 102 therebetween. A first bead of an adhesive material 140 can be placed between the rear lip 112 and the window pane 102, and a second bead of adhesive can be placed between the pane-retaining lip 124 and the window pane 102. The beads of adhesive 140, 142 affix the window pane 102 to the assembled metal frames 106, 120, and also form a substantially air-tight seal around the window pane 102. The assembled metal frames 106, 120 are sized and configured to transmit substantial impact loads and substantial pressure loads on the window pane 102 to the surrounding sheet metal face skin 15.

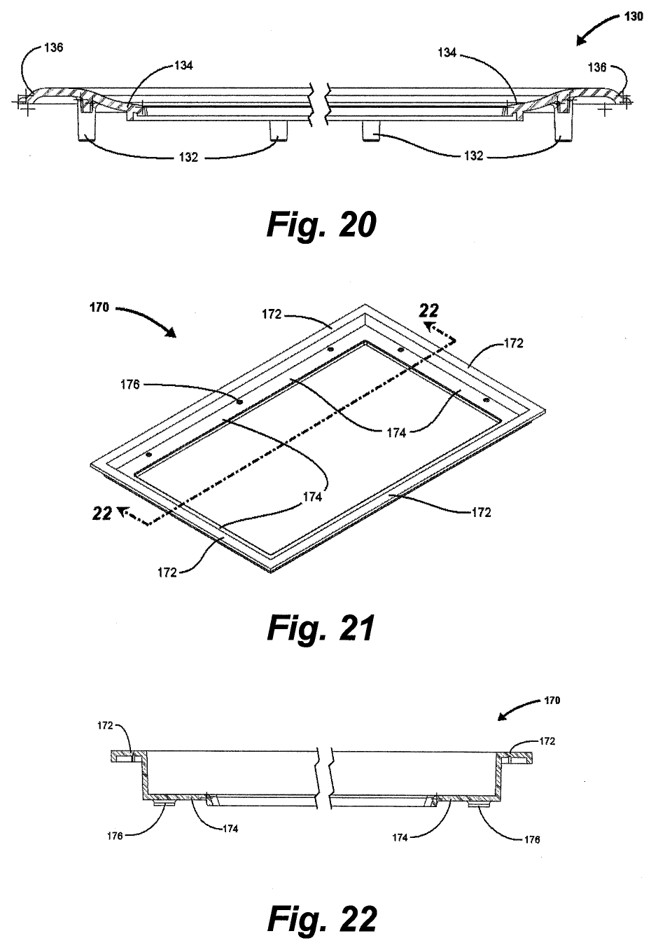

As shown in FIGS. 7 and 8, the window assembly 100 can further include an exterior trim member 130. Details of one embodiment of an exterior trim member 130 are shown in FIGS. 19 and 20. In the embodiment shown, the exterior trim member 130 has a substantially rectangular shape, and includes an inner edge portion 134 and an outer edge portion 136. As shown in FIGS. 7 and 20, the exterior trim member 130 also can include a plurality of rearwardly extending bosses 132. As shown in FIG. 7, the bosses 132 are configured to inwardly extend to the rear land 122 of the exterior metal frame 120, and to be secured to the connected exterior and interior metal frames 120, 106 by a second plurality of screws 150 that are received in aligned screw holes 114, 128 and bosses 132. As shown in FIGS. 7 and 8, when the exterior trim member 130 is connected to the metal frames 106, 120, the outer edge portions 136 contact an exterior surface of the face skin 15 of the door panel 12, and the inner edge portions contact an exterior surface of the window pane 102. Accordingly, the exterior trim member covers the exterior metal frame 130, hides the exterior metal frame from view from the outside of the door panel 12, and provides a finished appearance to the exterior outer edges of the window 100. In a preferred embodiment, the exterior trim panel 130 is constructed in a single piece from a molded polymeric material, such as high impact polystyrene, or the like. Preferably, exterior portions of the exterior trim member 130 include attractive architectural surface contours.

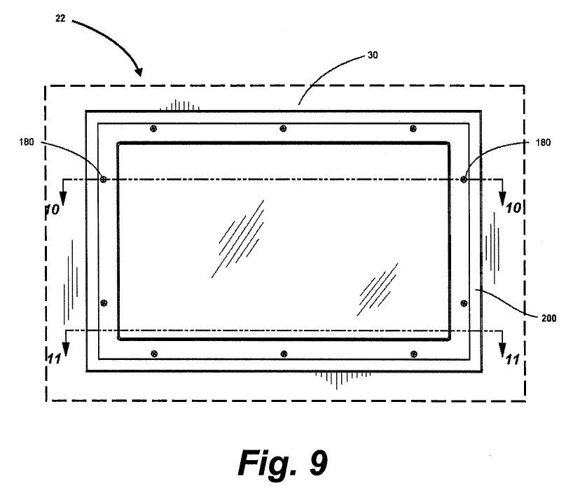

As shown in FIGS. 9-11, an interior metal frame 106, an exterior metal frame 120, a window pane 102, and an exterior trim member 130 as described above can also be used in an impact-resistant window assembly 200 installed in an insulated sheet metal door panel 22 having a face skin 25 and one or more thick insulation panels 30. In this embodiment, the window assembly 200 additionally includes an interior trim member 170. Details of one embodiment of the interior trim member 170 are shown in FIGS. 21 and 22. In this embodiment, the interior trim member 170 includes a forward flange 174 and a rear flange 172. The forward flange 174 can include a plurality of spaced screw holes 176 extending therethrough. In a preferred embodiment, the interior trim member 170 is constructed in a single piece from a molded polymeric material, such as high impact polystyrene, or the like.

As can be seen by comparing FIGS. 10 and 11 to FIGS. 7 and 8, the interior metal frame 106, the exterior metal frame 120, and the window pane 102 can be assembled together in a window opening 19 in a sheet metal face skin 25 of an insulated door panel 22 in a manner that is identical to the assembly described above for installation in an opening 17 in a face skin 15 of a non-insulated door panel 12 (as shown in FIGS. 7 and 8). In particular, the metal frames 106, 120 are connected together in the opening 19 by a first plurality of screws 160. When so connected, the forward lip 110 of the interior frame 106 and the exterior lip 126 of the exterior frame 120 again cooperate to sandwich edges of the face skin 25 around the opening 19 between the two frames 120, 106, thereby securely supporting the connected frames 106, 120 in the opening 19. In addition, the rear lip 112 of the interior frame 106 and the pane-retaining lip 124 of the exterior frame 120 again cooperate to receive and support a window pane 102 therebetween. As described above, a first bead of an adhesive material 140 can be placed between the rear lip 112 and the window pane 102, and a second bead of adhesive can be placed between the pane-retaining lip 124 and the window pane 102.

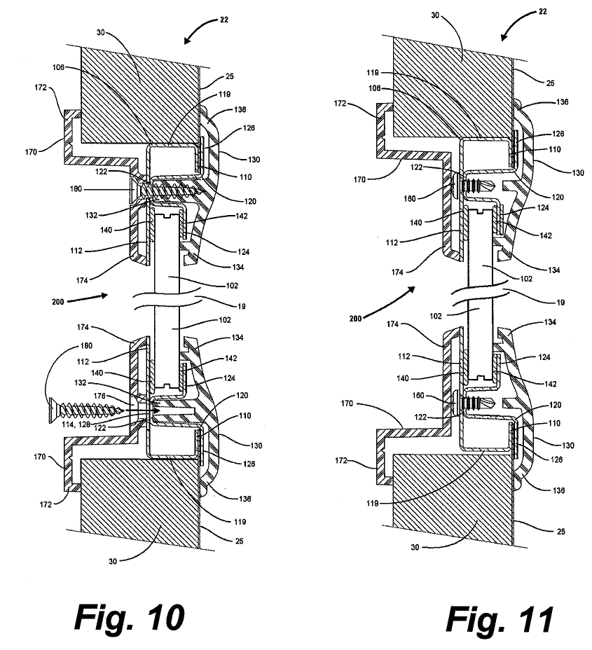

In this window assembly 200, both the exterior trim member 130 and the additional interior trim member 170 are connected to the adjoined metal frames 106, 120 by a third plurality of screws 180. The screws 180 are received in holes 176 in the interior trim member 170, aligned holes 114 and 128 in the connected metal frames 106, 120, and bosses 132 of the exterior trim member. As shown in FIGS. 10 and 11, when thus assembled in the opening 19, the outer edge portions of the exterior trim member contact the face skin 25, and the rear flange 172 of the interior trim member 170 contacts back surfaces of the insulation panel(s) 30. Accordingly, the interior trim member 170 and the exterior trim member 130 cooperate to sandwich the face skin 25 and the insulating panel 30 therebetween, and to at least partially secure the insulation panel 30 against a rear surface of the face skin 25. In addition, the rear flange 172 covers and protects the fragile edges of the insulation panel 30 that surround the window opening 19. The forward flange 174 of the interior trim member 170 substantially covers interior portions of the interior metal frame 106, thus shielding the interior frame 106 from view. The exterior trim member 130 and interior trim member 170 combine to provide a finished appearance to the outer edges of the window 200 on both the inside and outside of the glazed door panel 22.

The above description of various embodiments of the invention is provided to illustrate particular aspects and features of the invention, and not to limit the invention thereto. Persons of ordinary skill in the art will recognize that certain changes and modifications can be made to the described embodiments without departing from the invention. For example, though the impact-resistant window assemblies have been shown and described as being rectangular in shape, the windows can have substantially any polygonal or other outer shape. All such changes and modifications are intended to be within the scope of one or more of the appended claims.

What is claimed is:

1. A universal impact-resistant window assembly for a garage door of a type having a sheet-metal face skin, the window assembly being adaptable for installation in both insulated and non-insulated garage doors and comprising:
(a) an impact-resistant window pane;
(b) an interior metal frame configured to be installed within and around a window opening in the sheet-metal face skin;
(c) an exterior metal frame configured to be installed within and around the window opening in the sheet-metal face skin, wherein the exterior metal frame is configured to cooperate with the interior metal frame to engage portions of the sheet-metal face skin that surround the window opening, and to retain the window pane therebetween;
(d) an exterior trim member configured to substantially cover exterior portions of the exterior metal frame; and
(e) an optional interior trim member configured to substantially cover interior portions of the interior metal frame;
(f) wherein the interior trim member includes a rear flange configured to at least partially support an insulating panel proximate to the sheet-metal face skin when the window assembly is installed in an insulated door.

2. A universal impact-resistant window assembly according to claim 1 wherein the interior metal frame is connected to the exterior metal frame by a first plurality of removable fasteners.

3. A universal impact-resistant window assembly according to claim 2 wherein the outer trim member is connected to the interior and exterior metal frames by a second plurality of removable fasteners.

4. A universal impact-resistant window assembly according to claim 3 wherein the interior trim member and the exterior trim member are both connected to the interior and exterior metal frames by a third plurality of removable fasteners.

5. A universal impact-resistant window assembly according to claim 1 and further comprising an adhesive material disposed between portions of the window pane and adjacent portions of the exterior and interior metal frames.

6. A universal impact-resistant window assembly according to claim 1 wherein the exterior trim member covers at least some adjacent portions of an exterior surface of the sheet-metal face skin.

7. A universal impact-resistant window assembly according to claim 1 wherein the exterior and interior metal frames combine to retain the window pane in a position that is recessed behind the sheet-metal face skin.

8. A universal impact-resistant window assembly according to claim 1 wherein the exterior trim member and the interior trim member are constructed of at least one polymeric material.

9. An impact-resistant window assembly adapted for installation in a window opening in an insulated garage door or a non-insulated garage door, each door being of a type having a sheet metal face skin with a window opening therein, the window assembly comprising:
(a) a window pane;
(b) an interior metal frame having a forward lip and a rear lip, the rear lip being inwardly offset from the forward lip; and
(c) an exterior metal frame having an exterior lip, a rear land that is inwardly offset from the exterior lip, and a pane-retaining lip;
(d) wherein when the interior metal frame is disposed around the window opening on an interior side of the face skin, the forward lip of the exterior metal frame is disposed around the window opening on an exterior side of the face skin, and the interior metal frame is connected to the exterior metal frame, portions of the sheet metal face skin are sandwiched between the forward lip and the exterior lip, and the window pane is retained within the window opening between the rear lip and the pane-retaining lip.

10. An impact-resistant window assembly according to claim 9 wherein the interior metal frame is connected to the exterior metal frame by a first plurality of removable fasteners.

11. An impact-resistant window assembly according to claim 9 and further comprising at least one adhesive material disposed between the rear lip and the window pane, and between the pane-retaining lip and the window pane.

12. An impact-resistant window assembly according to claim 9 and further comprising an exterior trim member configured to substantially cover exterior portions of the exterior metal frame.

13. An impact-resistant window assembly according to claim 12 wherein the exterior trim member is attached to the interior and exterior metal frames by a second plurality of removable fasteners.

14. An impact-resistant window assembly according to claim 9 wherein the interior metal frame and exterior metal frame cooperate to retain the window pane in a plane that is inwardly offset from the sheet metal face skin.

15. A garage door including at least one impact-resistant window assembly for selective installation in either an insulated sheet metal door panel or a non-insulated sheet metal door panel, the window assembly comprising:
(a) an impact-resistant window pane;
(b) a frame arranged and constructed to securely support the window pane within a window opening in the sheet metal door panel; and
(c) an interior member configured to be optionally removably connected to an interior portion of the frame, the interior member having a rearwardly extending flange arranged and constructed to at least partially support one or more insulation panels proximate to an interior side of sheet metal door panel of an insulated sheet metal door panel;
(d) wherein the interior member can be excluded from the window assembly when the window assembly is installed in a non-insulated sheet metal door panel without one or more insulation panels.

16. A garage door according to claim 15 wherein the frame comprises an exterior frame portion and an interior frame portion that cooperate to capture and retain the window pane therebetween.

17. A garage door according to claim 16 and further comprising at least one adhesive material disposed between the window pane and the exterior frame portion, and between the window pane and the interior frame portion.

18. A garage door according to claim 15 wherein the frame supports the window pane within the window opening in a plane that is recessed below an exterior surface of the sheet metal door panel.

19. A garage door according to claim 15 wherein the frame is arranged and constructed to receive portions of the sheet metal door panel that border the window opening.

20. A garage door according to claim 15 and further comprising a removable exterior trim member configured to substantially shield the frame from view from a viewpoint that is on an exterior side of the door panel.
